(19) United States
(12) Patent Application Publication
(10) Pub. No.: US 2004/0044575 A1
(43) Pub. Date: Mar. 4, 2004

(54) Interactive retrofit capable loyalty device

(75) Inventors: Anton Bakker, Norfork, VA (US); Marc L. Allen, Chesapeake, VA (US)

Correspondence Address: NIXON PEABODY, LLP, 401 9TH STREET, NW, SUITE 900, WASINGTON, DC, 20004-2128, US

(73) Assignee: Outsite Networks, Inc., Norfolk, VA

(21) Appl. No.: 10/648,442

(22) Filed: Aug. 27, 2003

Related U.S. Application Data
(60) Provisional application No. 60/406,049, filed on Aug. 27, 2002.

(51) Int. Cl. G06F 17/60

(52) U.S. Cl. 705/14

(57) ABSTRACT

A loyalty system is retrofit into an existing retail or purchase transaction system such that the system is inserted between a reading device and the reading device's associated original controlling hardware. The loyalty system is then capable of receiving information read by the reader and, for example, passively reading the data as if it is being transferred from the reader to the reader's controller or, actively reading the data and then determining if all, a portion, or derivative of that data should be transferred to the existing retail system. For example, this basic technology can be used to allow the loyalty system to accept, for example, information from an RFID tag and submit magstripe data to a magstripe controller as if the magstripe reader had originally read the magstripe data.

### RELATED APPLICATION DATA

This application claims the benefit of and priority under 35 U.S.C. §119(e) to U.S. patent application Ser. No. 60/406,049, filed Aug. 27, 2002, entitled “Interactive Retrofit-Capable Loyalty Device,” which is incorporated herein by reference in its entirety.

### BACKGROUND OF THE INVENTION

1. Field of the Invention

The systems and methods of this invention generally relate to loyalty systems. In particular, the systems and methods of this invention at least relate to a retrofittable loyalty system and a loyalty point determination methodology.

2. Description of Related Art

Loyalty systems reward a customer for frequent use of services, frequent purchasing of goods, or the like. For example, frequent flyer miles are prime example of how airlines reward passengers for traveling on their particular airline. The reward, based on the number of “miles” accumulated can vary from discounts on future airline tickets, to seat upgrades, to free tickets, or the like.

Loyalty systems are becoming more popular as a retail mechanism for obtaining, retaining and rewarding returning customers. Before employing a loyalty system, a retailer determines if the benefits out way the costs. Loyalty systems have existed in may forms, from simple punch card applications to large-scale electronic systems designed to interface with, for example, grocery store systems.

Typically, a customer registers with a loyalty system and in turn receives a loyalty tag, i.e., identification device, associated with that particular system. Thus, to accumulate loyalty rewards, in conjunction with each purchase of a good or service, the customer uses their loyalty tag to identify themselves to the system thereby allowing the accumulation of a reward.

### SUMMARY OF THE INVENTION

However, one of the costs associated with implementing a new loyalty system is the initial capital required for the purchase of new equipment compatible with, for example, an existing point-of-sale system.

An exemplary embodiment of this invention can be used in conjunction with an existing retail or purchase transaction system, to provide coupons, points, rewards, advertising, custom content, or the like, for customers based on, for example, their loyalty, purchasing habits, and/or personal preferences. The system allows customers to interact with the loyalty system and existing purchase transaction system to claim, for example, coupons and/or rewards or to use the system to pay for a purchase.

Through the use of active and/or passive identification management translation capabilities, the system can be retrofit into existing systems, such as retail point-of-sale systems, gas pumps, or the like, and may utilize already existing hardware, such as magnetic card readers, receipt printers, audio devices, video displays, multimedia displays, and the like, and can also take advantage of a customer's existing identification tag to be used as both a payment mechanism and loyalty system identifier.

In particular, a user is identified by a loyalty network through the use of an information storage device, such as an ID tag, that contains at least one code unique to the user, such as a customer. The code is linked to a customer profile identifying customer loyalty and preference data. A reader reads the code from the ID tag and forwards the tag information either through a tag reader provided with the retrofit loyalty device or by listening to devices already present in the system, such as a magnetic card reader.

The loyalty system is retrofit into an existing retail or purchase transaction system such that the system is inserted between a reading device and the reading device's associated original controlling hardware. The loyalty system is then capable of receiving information read by the reader and, for example, passively reading the data as if it is being transferred from the reader to the reader's controller or, actively reading the data and then determining if all, a portion, or derivative of that data should be transferred to the existing retail system. For example, this basic technology can be used to allow the loyalty system to accept, for example, information from an RFID tag, and submit magstripe data to a magstripe controller as if, for example, the ,magstripe reader had originally read the magstripe data.

Upon the customer identifying themselves to the loyalty system, the associated customer code is forwarded to a loyalty system that optionally interacts with the customer and determines one or more loyalty rewards and dispenses these rewards in accordance with, for example, inputs received from a user, a customer profile, or the like.

More specifically, once a customer has identified themself to the loyalty device, the customer code is forwarded to, for example, a local loyalty server. The exemplary loyalty server passes the code on to a centralized loyalty host that uses the code to access the customer's loyalty and preference data, which may include information regarding which points, coupons, and loyalty rewards have been issued. The loyalty host then sends loyalty related information back to the local loyalty server, which, in coordination with the loyalty device, solicits customer input as to which coupons, rewards, or point allocations the customer would like to receive.

In addition, the loyalty device may interact with the customer through one of many methods, such as indicator lights indicating which inputs are available to be selected, a speaker outputting an audio message providing instruction as which inputs to use, a textual or video display showing which keys, or possibly touch screen locations, are active, and the like.

As will be appreciated, the tag and reader device can be any of a wired or wireless radio frequency system, a direct-contact system, an optical system, and electro or electro-mechanical system, or the like. Wireless radio frequency systems are often referred to as RFID, which typically operate in the frequency range of 60 khz to 5.8 Ghz. Common commercially available tags operate at 900 Khz, 125 Khz, 13.56 Mhz and 2.4 Ghz. In addition to RFID, direct contact systems include, for example, smart card and magstripe readers, and optical systems, such as bar code readers and the like.

Likewise, the user's identification device can be integrated into a small device and, for example, attached to a keychain. Examples, of these devices are the TIRIS® RFID tag by Texas instruments, the MIFAIR® RFID tag by Phillips, OTI RFID tags, Dallas Semiconductor's I-Button, and smart cards, such as those produced by Schlumberger and barcodes, such as those found in many grocery store loyalty systems.

Exemplary aspects of this invention relate to a loyalty network.

Exemplary aspects of the invention also relate to providing a retrofit-capable loyalty system.

Exemplary aspects of the invention further relate to analyzing tag data and forwarding one or more of the tag data, a portion of the tag data, or a derivative portion of data to a loyalty system.

Exemplary aspects of the invention additionally relate to using a tag as an alternative payment mechanism.

Exemplary aspects of the invention further relate to providing an interactive loyalty network that is capable of immediately issuing to a customer loyalty rewards.

These and other features and advantages of this invention as described in, or are apparent from, the following detailed description of the embodiments.

### BRIEF DESCRIPTION OF THE DRAWINGS

The embodiments of the invention will be described in detail, with reference to the following figures, wherein:

FIG. 1 is functional block diagram illustrating an exemplary loyalty network according to this invention;

FIG. 2 is a detailed functional block diagram of an exemplary loyalty system according to this invention; and

FIG. 3 is a flowchart outlining the exemplary operation of the loyalty network according to this invention.

### DETAILED DESCRIPTION OF THE INVENTION

The exemplary systems and methods of this invention will be described in relation to a loyalty system. However, to avoid unnecessarily obscuring the present invention, the following description omits well-known structures and devices that may be shown in block diagram form or otherwise summarized. For the purposes of explanation, numerous specific details are set forth in order to provide a thorough understanding of the present invention. It should be appreciated however that the present invention may be practiced in a variety of ways beyond the specific details set forth herein.

For example, the systems and methods of this invention can be scaled to any level and are capable of working in conjunction with or in supplement to various types of existing loyalty systems, customers, and already existing systems. Furthermore, while the exemplary embodiments illustrated herein show the various components of the loyalty network collocated, it is to be appreciated that various components of the network can be located at distant portions of a distributing network, such as a WAN, and/or the Internet, or within a dedicated loyalty network. Thus, it should be appreciated that the components of the loyalty system can be combined into one or more devices or collocated on a particular node of a distributed network, such as a communications network. It will be appreciated from the following description, and for reasons of computational efficiency, that the components of the loyalty system can be arranged at any location within a distributed network without affecting the operation of the system.

Additionally, it should be appreciated that the various links connecting the elements can be wired or wireless links, or any combination thereof, or any other know or later developed element(s) that is capable of supplying and/or communicating data to and from the connected elements. Additionally, the term module has as used herein can refer to any known or later developed hardware, software, or combination of hardware and software that is capable of performing the functionality associated with that element. Likewise, for example, to facilitate scaling of the system, one or more components of the loyalty system can mirrored and supplemented with, for example, load sharing functionality or be implemented in a distributed network type environment.

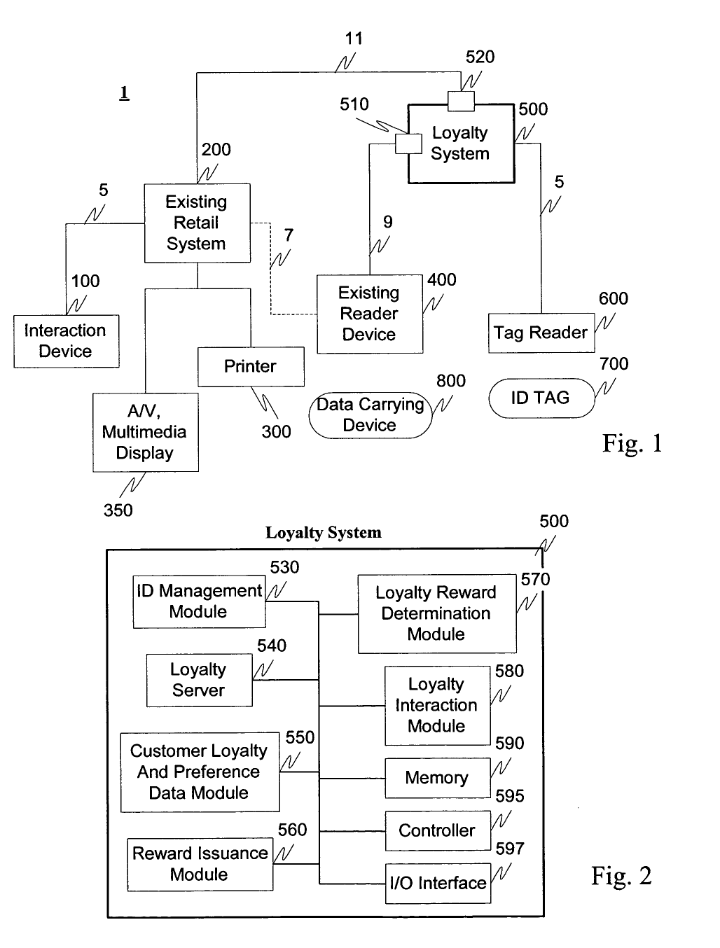

FIG. 1 illustrates an exemplary loyalty network 1. In particularly, the loyalty network 1 comprises an interaction device 100, an existing retail system 200, a printer 300, a audio, video and/or multimedia presentation device 350, an exiting reader device 400, a loyalty system 500, a plurality of interface devices 510 and 520 and a tag reader 600, a all interconnected by links. Furthermore, the loyalty network 1 comprises one or more ID tags 700, such as an RFID tag, and one or more data carrying devices 800, such as a credit card..

In operation, the existing retail system 200 that generally has attached devices, such as printer 300, and existing reader device 400, is retrofitted to the loyalty system 500 and associated additional optional loyalty components. In particular, the loyalty system 500, is adapted to communicate with the existing retail system 200 as well as with one or more of the devices attached to the existing retail system 200 such as the interaction device 100 the existing reader device 400 and one or more of the printer 300 and audio, video, multimedia display 350.

In accordance with a first exemplary embodiment, the existing retail system 200 is left essentially intact with the existing retail system 200 being connected to the interaction device 100, the printer 300, audio, video, multimedia display 350 and the existing reader device 400 to the existing retail system 200 via link 7. Supplementing this existing interconnectivity, the loyalty system 500 is connected via link 11 to the existing retail system 200.

In accordance with this exemplary embodiment, the loyalty system 500 cooperates with the existing retail system 200 to “listen in on” transaction information that is read by the existing reader device 400 connected to the existing retail system 200. Upon a customer introducing a data carrying device 800 to the existing reader device 400, the loyalty system 500 correlates a portion of the data read from the data carrying device 800, such as a credit card number, to a customers loyalty identifier. The loyalty system 500 then determines whether a loyalty reward is appropriate. If a loyalty reward is appropriate, the loyalty system 500 can forward a notification of such to the user via, for example, the printer 300, an audio, video or multimedia display 350, or the like. In addition, or alternatively, the loyalty system 500 can interact with the user, through the existing retail system, and via the interaction device 100, to further enhance the users experience by providing them with, for example, the option of immediately receiving the reward, receiving the reward at a later date, storing the reward, printing a coupon on printer 300, or the like.

In accordance with the second exemplary embodiment, the loyalty system 500 is interposed between and supplements the existing reader device 400 and the existing retail system 200. In particular, the existing reader device 400 is connected via link 9 and adapter 510 to the loyalty system 500. In turn, the loyalty system 500 is connected via adaptor 520 to the existing retail system 200 via a link 11. This allows, for example, as discussed hereinafter, the loyalty system 500 to one or more of actively or passively regulate communications between the existing reader device 400, the tag reader 600 and the existing retail system 200. For example, if the existing reader device 400 is a magnetic stripe reader, the loyalty system 500 can receive information associated with the magnetic stripe. The loyalty system can then one or more of forward this magnetic stripe information directly to the existing retail system 200, translate this information into other data and/or correlate the read information with, for example, a customer ID that could be related to, for example, a customer ID on ID tag 700 that could be associated with a customer loyalty profile.

Alternatively, for example, a customer is provided with the ability of using either the ID tag 700 in conjunction with the tag reader 600, or the data carrying device 800 in conjunction with the existing reader device 400 in order to identify themselves to the loyalty network 1 so they are entitled to receive loyalty rewards.

Specifically, in operation, a user can introduce the ID tag 700 into the sensible area of the tag reader 600. At this time, an identifier on the tag 700 is transferred via the tag read 600 to the loyalty system 500. The loyalty system 500 can then one or more of forward the tag identifier, a derivative of the tag identifier or information associated with the tag identifier to the existing retail system 200 that allows, for example, a transaction to purchase to occur in the traditional manner. For example, a credit card number can be derived from the tag identifier read by the tag reader 600, for example by referencing a customer loyalty profile, and forwarded to the existing retail system for processing the purchasing portion of the transaction while the loyalty system monitors specifics regarding the transaction such as amount spent, items purchased, categories of items purchased, historical transaction information, or the like, and determines any appropriate loyalty rewards.

As discussed before, the loyalty system 500 can also interact with a user via the interaction device 100 and query them, for example, as to whether they would like to immediately receive, for example, a coupon on printer 300, receive promotional advertising information via the audio, video, multimedia display 350, check the status of earned rewards, view or hear content, such as a news feed, advertising, or the like.

FIG. 2 illustrates an exemplary embodiment of the loyalty system 500 in greater detail. In particular, the loyalty system 500 comprises an ID management module 530, a loyalty server 540, a customer loyalty and preference data module 550, a reward issuance module 560, a loyalty reward determination module 570, a loyalty interaction module 580, a memory 590, a controller 595, and an I/O interface 597. In operation, the ID management module 530 receives from one or more of the existing reader device 400 or tag reader 600 data from an associated data carrying device that is capable of being read by the existing reader device 400 or via the tag reader 600. The ID management module 530 interprets and manipulates this data, if necessary, depending on the particular installation and whether or not the data needs translation prior to being forwarded to the existing retail system 200. For example, if the existing reader device 400 reads data from a credit card, the loyalty system 500, and in particular the ID management module 530, could forward the credit card information via links 9 and 11 directly to the existing retail system 200. Alternatively, the existing reader device 400 can forward the credit card information, as was done prior to installation of the loyalty system 500 to the existing retail system 200 via link 7. With either methodology, both the loyalty system 500 and the existing retail system 200 are capable of accessing the credit card information. With the credit card information, the loyalty system 500 can correlate the credit card information to, for example, a particular user's loyalty identification. Then, as discussed above, the loyalty system 500 can determine any rewards, or the like, based on this user identification.

Alternatively, if the tag 700 is introduced to the tag reader 600, the ID management module 530, upon receiving the identifier stored on tag 700 can correlate the read identifier with, for example, a credit card number that could be forwarded to the existing retail system 200 for processing of the purchase transaction.

Having received or determined a loyalty identifier for one or more of the tag 700 and the data carrying device 800, the loyalty server 540, in conjunction of one or more of the memory 590, controller 595, I/O interface 597 and customer loyalty and preference data module 550 determines if, for example, the user is enrolled in a particular loyalty program(s) and whether the customer has any loyalty or preference data associated with that enrolled program. For example, the loyalty and preference data can include historical information, such as past transactions, rewards earned, or the like, and the preference data can indicate, for example, whether the user likes to receive immediate notice of rewards earned, coupons based on rewards earned, information displayed, advertisements, or the like. Furthermore, the preference data can optionally include instructions that specify the loyalty system 500 is to interact with the user via the interaction device 100, such as a keypad, audio and/or video messaging device, touch screen, or the like, to determine in real-time or near real-time what a users preferences may be for the current transaction.

Assuming a user is a member of a loyalty program and entitled to a loyalty reward, the loyalty reward determination module 570, in cooperation with one or more of the loyalty interaction module 580 and reward issuance module 560 determines a reward, if appropriate, and, as discussed above, based on preference data, one or more of issues to reward, updates stored reward information, or queries the customer, via interaction device 100, for input as to how to handle the reward.

In addition, the loyalty interaction module 580 need not be limited to specific transactions directed toward the consumption, receipt or acknowledgment of rewards, but can also be used to allow an existing retail system 200 to have enhanced capabilities provided by the loyalty system 500 via one or more of the interaction device 100 and the printer 300 and/or the audio, video or multimedia display 350. For example, while a user may not be entitled to a particular loyalty reward based on a current transaction, the user may nevertheless like to receive certain content via one or more of the printer 300 and audio/video multimedia display 350. Thus, this content can be based on information stored in the preference data associated with the user, or, for example, provided to the user as selectable options at interaction device 100.

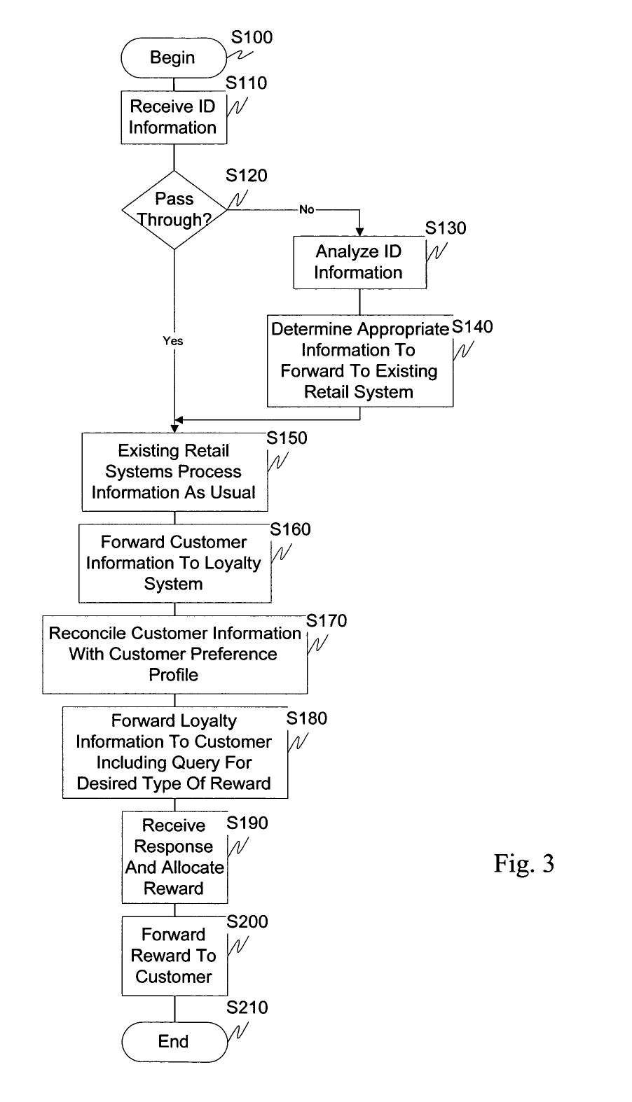

FIG. 3 outlines an exemplary method of operation for the loyalty network. In particular, control begins in step S100 and continues to step S110. In step S110, identification information is received from one or more of a data carrying device or a tag. Next, in step S120, a determination is made whether to pass the received identification information directly through to the existing retail system. If the identification information is to be passed directly through, control jumps to step S150. Otherwise, control continues to step S130. In step S130, identification information is analyzed. Next, in step S140, a determination is made as to which appropriate information should be forwarded to the existing retail system and the information forwarded thereto. Control then continues to step S150.

In step S150, the existing retail system processes the information as usual for, for example, the current sale transaction. Next, in step S160, customer information is forwarded to the loyalty system. As discussed above, this customer information can be derived from the data stored on the ID tag or the data carrying device or, for example, can be the data on the data carrying devices themselves. Next, in step S170, the customer information is reconciled with the customer preference profile. Then, in step S180, the loyalty information is forwarded to the customer including, for example, queries asking the user how they would like reward, if any, handled. Control then continues to step S190.

In step S190, a response is optionally received from the user and an award allocated, stored, printed, or the like, and handled appropriately. Next, in step S200, the reward, or a notification of how the reward was handled, is forwarded to the customer. Control then continues to step S210 where the control sequence ends.

The above-described systems and methods can be implemented on a loyalty system, marketing system, advertising system, or the like, or on a separate programmed general purpose computer having loyalty capabilities. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, stored as instructions on a recordable media, or the like. In general, any device capable of implementing a state machine that is in turn capable of implementing the flowcharts illustrated herein can be used to implement the system according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and loyalty system arts.

Moreover, the disclosed methods may be readily implemented in software executed on programmed general purpose computer, a special purpose computer, a microprocessor, or the like. In these instances, the systems and methods of this invention can be implemented as program embedded on personal computer such as JAVA® or CGI script, as a resource residing on a server or graphics workstation, as a routine embedded in a loyalty system, or the like. The system can also be implemented by physically incorporating the system and method into a software and/or hardware system, such as the hardware and software systems of a loyalty reward system.

It is, therefore, apparent that there has been provided, in accordance with the present invention, systems and methods for a loyalty reward system. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A loyalty system comprising:
at least one adapter, the adapter configured to allow communication between an existing transaction system and the loyalty system; and
a identification management module adapted to receive an identifier from one or more of a data carrying device and an identification tag, the identification management module capable of determining a loyalty system identifier and purchase information, the loyalty system identifier capable of identifying a user to the loyalty system and the purchase information capable of paying for a purchase at an existing retail system.

2. The system of claim 1, wherein a data carrying reader is connected to the existing retail system.

3. The system of claim 1, wherein a data carrying reader is connected to the loyalty system by an interface.

4. The system of claim 3, wherein the identification management module receives the identifier from the data carrying device and one or more of passes the identifier directly to the existing retail system and determines the purchase information at least based on the identifier and user profile information.

5. The system of claim 1, further comprising a loyalty server configured to cooperate with an interaction device connected to the existing retail system, the interaction device adapted to receive inputs from a user.

6. The system of claim 1, further comprising a user loyalty and preference data module that at least one of stores user information, user credit card information, user preference information, reward information, transaction information and loyalty information.

7. The system of claim 1, further comprising a loyalty reward determination module.

8. The system of claim 1, further comprising a reward issuance module, the reward issuance module adapted to cooperate with an interaction device and a loyalty interaction module to issue a reward based on an input received from the interaction device.

9. The system of claim 1, further comprising one or more of a printer, an audio device, a video display, and a multimedia display.

10. The system of claim 1, further comprising a user interaction device adapted to receive input from a user.

11. A method of operating a loyalty system comprising:
installing an adapter configured to allow communication between an existing transaction system and the loyalty system;
receiving an identifier from one or more of a data carrying device and an identification tag; and
determining a loyalty system identifier and purchase information, the loyalty system identifier capable of identifying a user to the loyalty system and the purchase information capable of paying for a purchase at an existing retail system.

12. The method of claim 11, further comprising connecting a data carrying reader to the existing retail system.

13. The method of claim 11, further comprising connecting a data carrying reader to the loyalty system by an interface.

14. The method of claim 13, further comprising receiving the identifier from the data carrying device and one or more of passing the identifier directly to the existing retail system and determining the purchase information at least based on the identifier and user profile information.

15. The method of claim 11, further comprising communicating with an interaction device connected to the existing retail system, the interaction device adapted to receive inputs from a user.

16. The method of claim 11, further comprising storing at least one of user information, user credit card information, user preference information, reward information, transaction information and loyalty information.

17. The method of claim 11, further comprising determining a loyalty reward.

18. The method of claim 11, further comprising issuing a reward based at least on an input received from the interaction device.

19. The method of claim 11, further comprising printing a coupon, playing audio, displaying video, and presenting multimedia.

20. The method of claim 11, further comprising receiving interactive input from a user based at least on loyalty reward information.

21. A loyalty system comprising:
means for installing an adapter configured to allow communication between an existing transaction system and the loyalty system;
means for receiving an identifier from one or more of a data carrying device and an identification tag; and
means for determining a loyalty system identifier and purchase information, the purchase information capable of paying for a purchase at an existing retail system and the loyalty system identifier capable of identifying a user to the loyalty system.
